(19) United States
(12) Patent Application Publication
(10) Pub. No.: US 2004/0114825 A1
(43) Pub. Date: Jun. 17, 2004

(54) Method of filtering video sources

(76) Inventor: Tzong-Der Wu, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/317,501

(22) Filed: Dec. 12, 2002

(51) Int. Cl. G06K 9/40

(52) U.S. Cl. 382/261

(57) ABSTRACT

A method of filtering video sources. A video having at least a first frame and a second frame and filter parameters is first received. Then, a designated portion of the body is set. Thereafter, an object and a corresponding face portion in the first frame are detected, and a skeleton of the object is determined. Then, the designated portion in the object is found according to the position of the face portion and the skeleton, and an adaptive filter is generated on the designated portion in the first frame. Afterward, the designated portion in the second frame is motion tracked, and another adaptive filter is generated on the designated portion in the second frame.

### BACKGROUND OF THE INVENTION

1. Field of the Invention

The present invention relates to a filtering method, and particularly to a filtering method that automatically filters objects in video sources, such as digitizing the objects in video sources.

2. Description of the Related Art

With respect to human rights, persons or other items appearing in video programs, such as criminal suspects or locational elements, must be rendered unidentifiable. Filtering methods such as digitizing the face of suspects are used. In addition, restricted portions or objectionable displays need also be filtered before broadcast.

In conventional practice, the filtering process is operated manually, that is, a specified portion frame by frame is searched, and an adaptive filter is applied to the designated portion of each frame manually. The conventional filtering method on video is time- and resource-consuming.

### SUMMARY OF THE INVENTION

It is therefore an object of the present invention to provide a filtering method that automatically adds adaptive filters to objects in video sources.

To achieve the above object, the present invention provides a method of filtering video sources. According to a first embodiment of the invention, a video having at least a first frame and a second frame and filter parameters is first received. Then, an object in the first frame is detected and designated. Thereafter, an adaptive filter is generated according to the filter parameters, and the adaptive filter is added to the designated object in the first frame. Afterward, the designated object in the second frame is motion tracked, and another adaptive filter is generated and added to the designated object in the second frame.

According to a second embodiment of the invention, a video having at least a first frame and a second frame and filter parameters are first received. Then, a designated portion of body is received. Thereafter, an object in the first frame is detected. Then, a face portion of the object is detected, and a skeleton of the object is determined.

Thereafter, the designated portion in the object is found according to the position of the face portion in the object and the skeleton. Then, an adaptive filter is generated according to the filter parameters, and the adaptive filter is added to the designated portion in the first frame.

Afterward, the designated portion in the second frame is motion tracked, and another adaptive filter is generated and added to the designated portion in the second frame.

The filter parameters may include the size of filter and the level of digitization. The object detection method may be the edge detection method or the frame difference method. The method of generating an adaptive filter performs discrete cosine transformation (DCT) on the designated object or portion, and filters parts of frequency space of the designated object or portion according to the required level of digitization.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a flowchart illustrating the method of filtering video sources according to the first embodiment of the present invention;

FIG. 2 is a flowchart illustrating the method of filtering video sources according to the second embodiment of the present invention;

FIG. 3A shows an object; and

FIG. 3B shows the skeleton of the object in FIG. 3A.

### DETAILED DESCRIPTION OF THE INVENTION

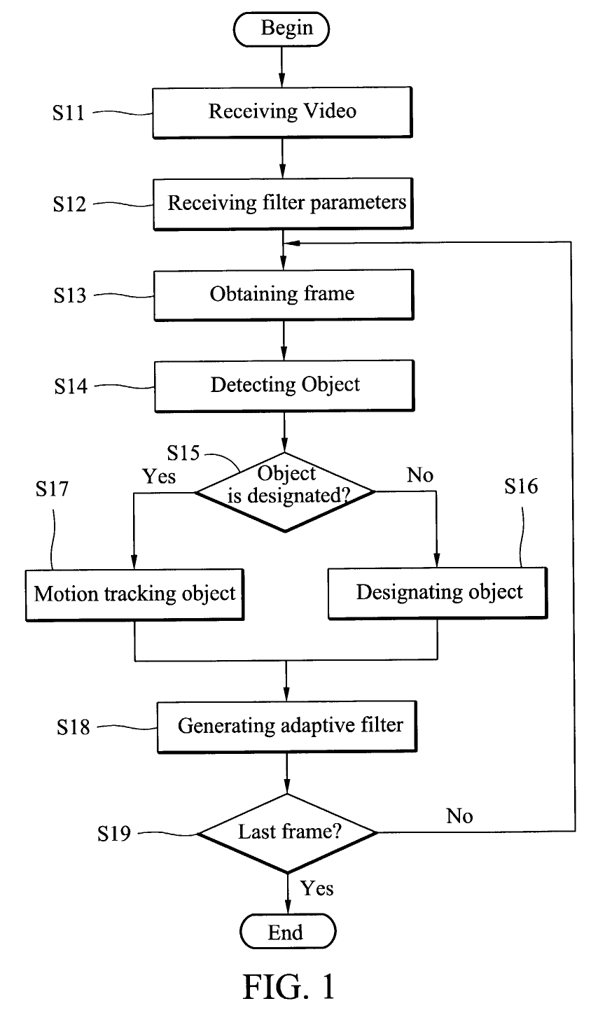

FIG. 1 illustrates the method of filtering video sources according to the first embodiment of the present invention.

In the first embodiment, the objects in the video frames are detected automatically. Users can designate at least one object to be motion tracked and receive an adaptive filter in other video frames.

First, in step S11, a video having a plurality of frames is received, and in step S12, filter parameters are received. The filter parameters may include the size of filter and the level of digitization.

Then, in step S13, the first frame of the video is obtained. Thereafter, in step S14, objects in this frame are detected. It should be noted that the object detection method may be edge detection or frame difference method, but is not limited to this. After the objects are detected, in step S15, at least one object is checked for designation. Note that the designated object is that requiring application of an adaptive filter. If no designated object is yet designated (no in step S15), in step S16, an object can be designated by users.

Thereafter, in step S18, an adaptive filter is generated according to the filter parameters, and added to the designated object in this frame. Many image and video compression schemes perform discrete cosine transformation (DCT) to represent image data in frequency space. The method of generating adaptive filter performs discrete cosine transformation (DCT) on the designated object, and filters parts of frequency space, such as the DC or high frequency space of the designated object according to the necessary level of digitization, thereby digitizing the designated object. Note that not only digitization but any other method of filtering can be employed in the present invention.

Then, in step S19, the frame is checked for whether it is the last frame of the video. If not (no in step S19), the flow returns to step S13 to obtain the next frame.

Afterward, in step S14, objects in this frame are detected. Since the designated object has already been determined (yes in step S15), in step S17, the designated object in this frame is now motion tracked. It should be noted that the motion tracking method is a mature technique, for example, motion tracking can be achieved by comparing the position of the designated object in two frames.

After the designated object is found, in step S18, another adaptive filter is generated according to the filter parameters, and added to the designated object in the current frame. Similarly, the method of generating adaptive filter performs discrete cosine transformation (DCT) on the designated object, and filters parts of frequency space of the designated object according to the necessary level of digitization, thereby digitizing the designated object.

Then, in step S19, the frame is checked for whether it is the last frame of the video. If yes (yes in step S19), then the operation is finished.

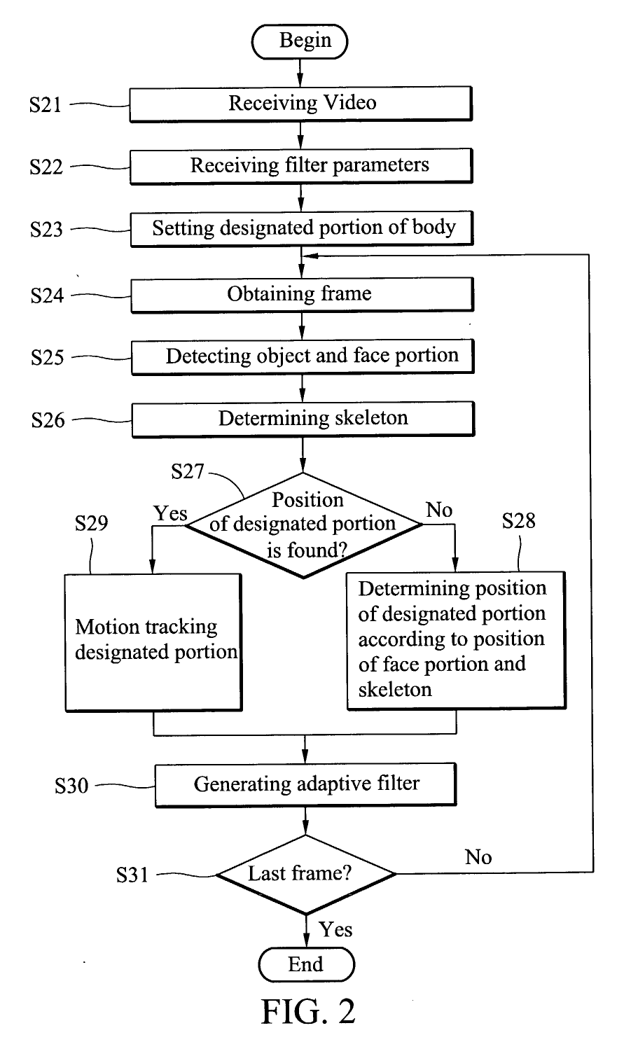

FIG. 2 illustrates the method of filtering video sources according to the second embodiment of the present invention.

In the second embodiment, the designated portion of body, such as hand or face that needs to be filtered can be received or determined at first. After video frames are received, the designated portion can be motion tracked automatically and added an adaptive filter on it.

First, in step S21, a video having a plurality of frames is received, and in step S22, filter parameters are received. The filter parameters may include the size of filter and the level of digitization.

Then, in step S23, a designated portion of the body is received or set by users. Thereafter, in step S24, the first frame of the video is obtained, and in step S25, objects in this frame are detected, and a face portion of each detected object is detected. Note that the object detection method may be the edge detection method or the frame difference method, but is not limited to this. In addition, the face portion can be detected according to facial characteristics such as color, shape, and others. It also should be noted that users can designate an object for tracking if several objects are detected in the frame.

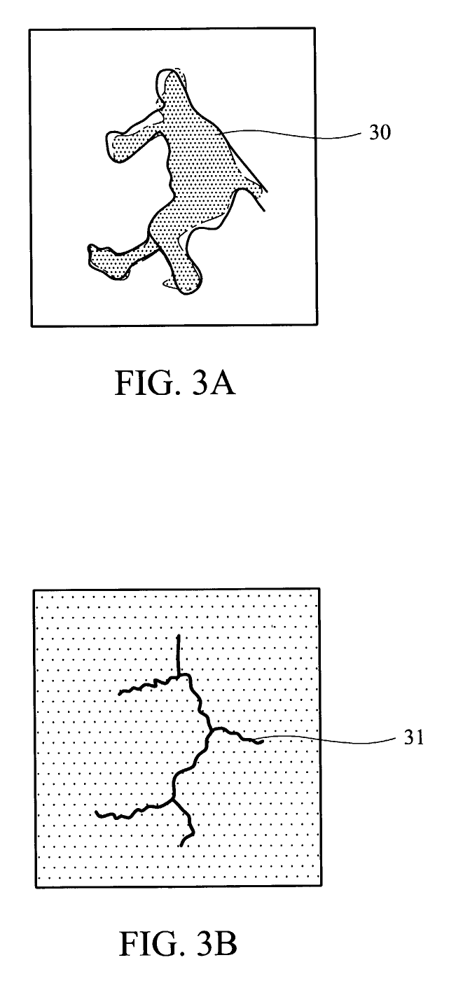

After the object and corresponding face portion are detected, in step S26, a skeleton of the object is determined. For example, FIG. 3A shows an object 40, and the skeleton 41 of the object 40 is shown in FIG. 3B. The method for skeleton determination processes all contour points within the region of the object with the following steps.

Condition 1: the right boundary points, lower boundary points, or left-upper corner point are not end point, and the width of each point is not equal to 1;

Condition 2: the upper boundary points, left boundary points, or right-lower corner points are not end point, and the width of each point is not equal to 1.

In the region of the object, the contour points conform to condition 1 and 2 are deleted alternately and repeatedly, until no contour point conforms to condition 1 and 2. The center of gravity of the remained points is the skeleton of the object. It should be noted that the above method for skeleton determination is only one example, and is not limited to this.

Then, in step S27, it is determined whether the designated portion has been found or not. If not (no in step S27), in step S28, the designated portion in the object is found according to the position of the face portion in the object and the skeleton.

Then, in step S30, an adaptive filter is generated according to the filter parameters, and the adaptive filter is added to the designated portion of the object in the frame in the position of the designated portion. Similarly, the method of generating adaptive filter performs discrete cosine transformation (DCT) on the designated portion, and filters parts of frequency space, such as the DC or high frequency space of the designated portion according to the necessary level of digitization, thereby digitizing the designated portion. Note that, in addition to digitization, any method of filter generation can be employed in the present invention.

Thereafter, in step S31, the frame is checked for whether it is the last frame of the video. If not (no in step S31), then the flow returns to step S24 to obtain the next frame. Then, in step S25 and S26, objects and corresponding face portions in the frame are detected and the skeleton of each detected object is determined.

Since the position of the designated object is already determined in the last frame (yes in step S27), in step S29, the designated portion in this frame is motion tracked by tracking the move of the skeleton. After the designated portion is found, in step S30, another adaptive filter is generated according to the filter parameters, and the adaptive filter is added to the designated portion in the current frame in the position of the designated portion. Similarly, the method of generating adaptive filter performs discrete cosine transformation (DCT) on the designated portion, and filters parts of frequency space of the designated portion according to the necessary level of digitization, thereby digitizing the designated portion.

Then, in step S31, the frame is checked for whether it is the last frame of the video. If not, the flow returns to step S24, otherwise, the operation is finished.

According to another aspect, the method of filtering video sources of the present invention can be encoded into computer instructions (computer-readable program code) and stored in computer-readable storage media.

As a result, using the method of filtering video sources according to the present invention, adaptive filters can be automatically added to objects in video sources, so as to conserve resources.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method of filtering video sources, comprising the steps of:
receiving a video having at least a first and second frames;
detecting at least one object in the first frame;
designating the object;
generating an adaptive filter on the designated object in the first frame;
motion tracking the designated object in the second frame; and
generating another adaptive filter on the designated object in the second frame.

2. The method as claimed in claim 1 further comprising receiving filter parameters.

3. The method as claimed in claim 2 wherein the adaptive filter is generated according to the filter parameters.

4. The method as claimed in claim 2 wherein the filter parameters comprise the size of the adaptive filter.

5. The method as claimed in claim 2 wherein the filter parameters comprise the level of digitization of the adaptive filter.

6. The method as claimed in claim 1 wherein the method of generating the adaptive filter performs discrete cosine transformation (DCT) on the designated object, and filters parts of frequency space of the designated object.

7. The method as claimed in claim 5 wherein the method of generating the adaptive filter performs discrete cosine transformation (DCT) on the designated object, and filters parts of frequency space of the designated object according to the necessary level of digitization.

8. The method as claimed in claim 1 wherein the object is detected by edge detection method.

9. The method as claimed in claim 1 wherein the object is detected by employing a frame difference method.

10. A method of filtering video sources, comprising the steps of:
receiving a video having at least a first frame and a second frame;
setting a designated portion of the body;
detecting at least one object in the first frame;
detecting a face portion of the object;
determining a skeleton of the object;
finding the designated portion in the object according to the position of the face portion in the object and the skeleton;
generating an adaptive filter on the designated portion in the first frame;
motion tracking the designated portion in the second frame; and
generating another adaptive filter on the designated portion in the second frame.

11. The method as claimed in claim 10 further receiving filter parameters.

12. The method as claimed in claim 11 wherein the adaptive filter is generated according to the filter parameters.

13. The method as claimed in claim 11 wherein the filter parameters comprise the size of the adaptive filter.

14. The method as claimed in claim 11 wherein the filter parameters comprise the level of digitization of the adaptive filter.

15. The method as claimed in claim 10 wherein the method of generating the adaptive filter performs discrete cosine transformation (DCT) on the designated object, and filters parts of frequency space of the designated object.

16. The method as claimed in claim 14 wherein the method of generating the adaptive filter performs discrete cosine transformation (DCT) on the designated object, and filters parts of frequency space of the designated object according to the necessary level of digitization.

17. The method as claimed in claim 10 wherein the object is detected by edge detection method.

18. The method as claimed in claim 10 wherein the object is detected by frame difference method.
